(19) United States
(12) Patent Application Publication
(10) Pub. No.: US 2020/0301258 A1
(43) Pub. Date: Sep. 24, 2020

(54) FENCE MOUNT

(71) Applicants: Michael W. Lowe, Santa Cruz, CA (US); Satya Narayan Braj Mohan, Foster City, CA (US)

(72) Inventors: Michael W. Lowe, Santa Cruz, CA (US); Satya Narayan Braj Mohan, Foster City, CA (US)

(21) Appl. No.: 16/827,611

(22) Filed: Mar. 23, 2020

Related U.S. Application Data
(60) Provisional application No. 62/822,139, filed on Mar. 22, 2019.

(51) Int. Cl. G03B 17/56; F16M 13/02

(52) U.S. Cl. CPC G03B 17/561; E04H 17/02; F16M 13/022

(57) ABSTRACT

In one embodiment, a mounting device engageable with a fence includes a mounting platform from which a first engaging member and a second engaging member extend. The first engaging member includes a number of receptacles configured to receive a portion of a fence wire, and the second engaging member includes a number of receptacles configured to receive a portion of a fence wire. In one form, a portion of the first engaging member including the number of receptacles is movable relative to the mounting platform and a portion of the second engaging member including the number of receptacles is movable relative to the mounting platform. The mounting device may be used, for example, in connection with the positioning of one or more items relative to the fence.

### CROSS REFERENCE TO RELATED APPLICATIONS

This application claims priority to U.S. Provisional Patent Application No. 62/822,139 filed Mar. 22, 2019, the contents of which are incorporated herein by reference in their entirety

### FIELD

The present disclosure generally relates to devices configured for engagement with a fence. More particularly, but not exclusively, the present disclosure relates to a device which is engageable with a fence and provides a mounting platform for one or more other items.

### BACKGROUND

Unless otherwise indicated herein, the materials described herein are not prior art to the claims in the present application and are not admitted to be prior art by inclusion in this section.

Certain areas or locations may include one or more fences or sections of fences. Instances may arise when it may be desirable to attach or position one or more items on the fence. For example, it may be desirable to attach cameras, signs, or other objects to a fence. From time to time, it may also be desirable to remove these objects from the fence or change their positioning relative to the fence.

The subject matter claimed herein is not limited to embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In one embodiment, a mounting device engageable with a fence includes a mounting platform, a first engaging member extending from the mounting platform and including a number of receptacles configured to receive a portion of a fence wire, and a second engaging member extending from the mounting platform and including a number of receptacles configured to receive a portion of a fence wire. A portion of the first engaging member including the number of receptacles is movable relative to the mounting platform and a portion of the second engaging member including the number of receptacles is movable relative to the mounting platform.

In another embodiment, a method for engaging a mounting device to a fence includes positioning a portion of a first engaging member of the mounting device on a first side of the fence and receiving a portion of a fence wire in a receptacle of the first engaging member, and positioning a portion of a second engaging member of the mounting device on the first side of the fence and receiving a portion of a fence wire in a receptacle of the second engaging member. The method also includes maintaining a mounting platform from which the first engaging member and the second engaging member extend on a second side of the fence opposite the first side of the fence.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a front perspective view of a mounting device;

FIG. 2 is a rear perspective view of the mounting device of FIG. 1;

FIG. 3 is a side view of the mounting device of FIG. 1;

FIG. 4 is a front perspective view of an alternative embodiment mounting device;

FIG. 5 is a rear perspective view of the mounting device of FIG. 4;

FIG. 6 is a perspective view of the mounting device of FIG. 4 including a mounting extension and a recording device;

FIGS. 7 and 8 are perspective views of the mounting device of FIG. 4 including a mounting extension and a recording device engaged with a fence; and

FIGS. 9 and 10 are perspective views of a mounting extension.

### DETAILED DESCRIPTION

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

The present disclosure generally relates to devices configured for engagement with a fence and related techniques for use of the same. More particularly, but not exclusively, the present disclosure relates to a device which is engageable with a fence and provides a mounting platform for one or more other items. Although the embodiments are described in the context of mounting or positioning one or more items relative to a fence, it will be appreciated that embodiments disclosed herein may be employed in other fields and/or operating environments where the functionality disclosed herein may be useful. Accordingly, the scope of the invention should not be construed to be limited to the exemplary implementations and operating environments disclosed herein.

In some forms, the present disclosure relates to a device which is engageable with a fence and provides a mounting platform for one or more other items. In some aspects, the device is engageable with a wire-based fence such as a chain link fence, chicken wire fence, or farm fence, just to provide a few examples. Non-limiting examples of items that may be mounted, temporarily or otherwise, to a fence include phones, cameras, signage, coaching instructions, white boards, or speakers, and the areas where such fences may exist may be indoors or outdoors and include, for example, baseball fields or diamonds, batting cages, tennis courts, basketball courts, swimming pools, dog parks, multi-purpose sporting fields, golf driving ranges, and building construction sites.

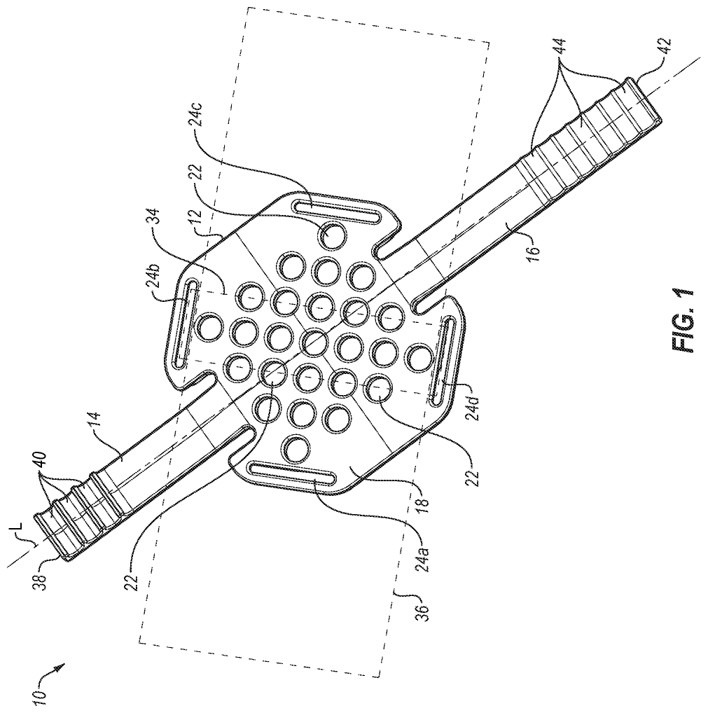

Referring now to FIGS. 1-3, one non-limiting mounting device 10 includes a mounting platform 12 from which a first engaging member 14 and a second engaging member 16 extend. The mounting platform 10 has a generally planar configuration which extends between a first surface 18 and an opposite second surface 20. A plurality of mounting holes 22, only a few of which have been identified for the sake of clarity, extend through the mounting platform 10 and open at the first surface 18 and the second surface 20. A plurality of slots 24a-24d also extend through the mounting platform 10 and open at the first surface 18 and the second surface 20.

In the illustrated form, the mounting platform 12 includes a generally octagonal configuration, although forms where the mounting platform 12 may have a square, rectangular, circular or oval configuration are possible. Forms of the mounting platform 12 which are non-planar or partially planar, such as curvelinear, are also possible. The first surface 18 of the mounting platform 12 is flat in the illustrated form, although in other forms it may include variations in its configuration. In some forms for example, the first surface 18 of the mounting platform 12 may include textures, patterns, or other deviations from a flat surface. The second surface 20 of the mounting platform 12 is also flat in the illustrated form, although in other forms it may include variations in its configuration. In some forms for example, the second surface 20 of the mounting platform 12 may include textures, patterns, or other deviations from a flat surface.

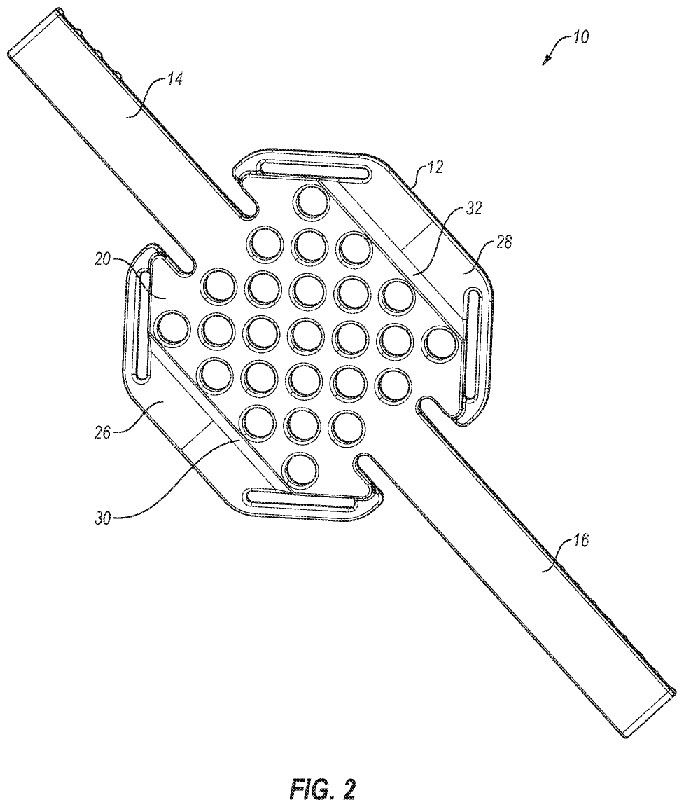

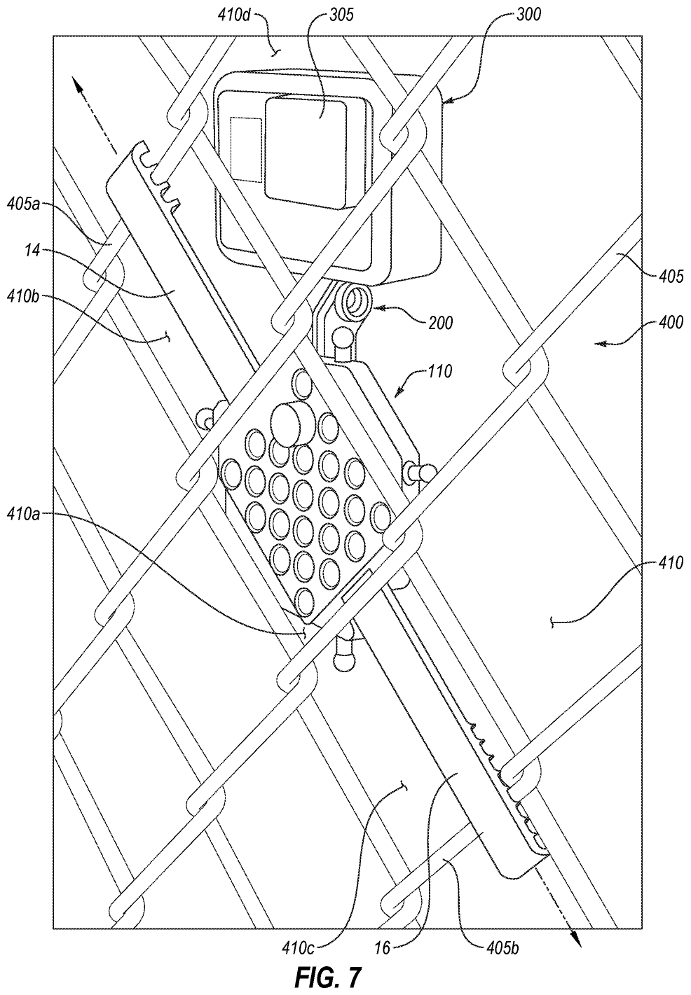

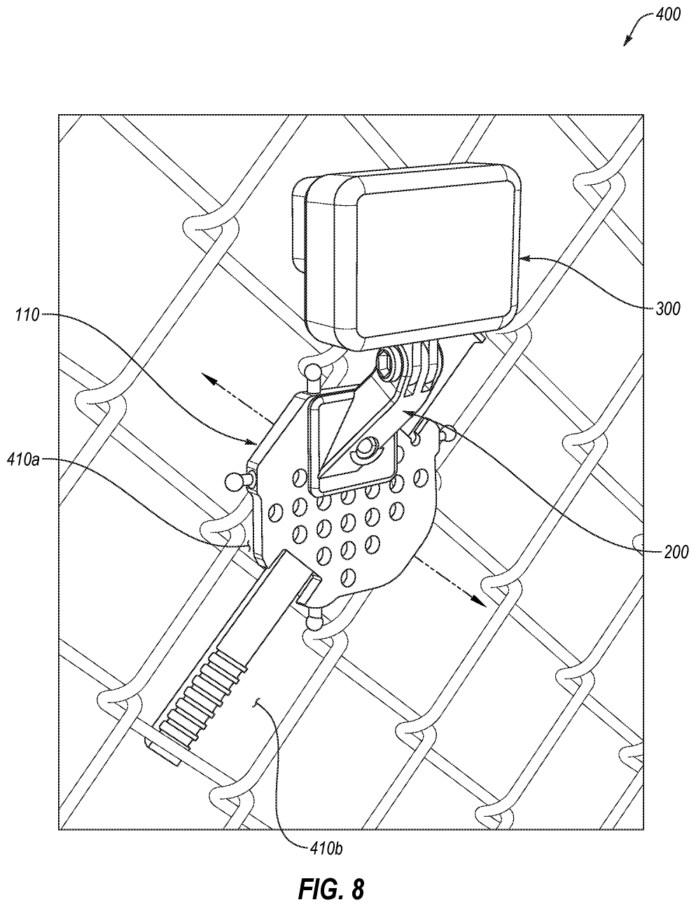

As best seen in connection with FIG. 2 for example, the mounting platform 12 also includes surfaces 26 and 28 positioned on opposite sides of the second surface 20. The surfaces 26 and 28 are recessed relative to the second surface 20 or, stated alternatively, the second surface 20 extends beyond the surfaces 26 and 28. A concave surface 30 provides a transition between the surface 26 and the second surface 20, and a concave surface 32 provides a transition between the surface 28 and the second surface 20. In the illustrated form, the concave surfaces 30 and 32 extend inline with or parallel to the first and second engaging members 14 and 16, although forms in which one or both of the concave surfaces 30 and 32 extend transversely to the first and second engaging members 14 and 16 are possible. When the mounting device 10 is engaged with a fence, such as a chain link fence for example, a portion of the fence may be positioned on or adjacent to one or both of the concave surfaces 30 and 32, further details of which will be discussed below in connection with FIGS. 7 and 8. For example, with the second surface 20 spacing the concave surface 30 and 32, the concave surfaces 30 and 32 may be positioned to interact with a chain link fence having a particular mesh size. For example, mesh sizes for chain link fences may include, amongst other sizes, 2 inches, 2¼ inches, 2⅜ inches, and 1¾ inches. Depending on a particular application, the concave surfaces 30 and 32 may be separated by a distance corresponding with the mesh size of the fence to which the mounting device 10 may be engaged.

Forms in which the second surface 20 extends entirely across the mounting platform are also possible such that surfaces 26 and 28 are not present. Additionally or alternatively, the mounting platform may be configured such that surfaces similar to surfaces 26 and 28 are positioned on opposite sides of the first surface 18.

As indicated above, a plurality of mounting holes 22 extend through the mounting platform 12. Forms where a single mounting hole 22 is present or the mounting holes 22 are entirely absent are also contemplated. The mounting holes 22 may be provided in a random or defined pattern, and they may be provided with the same or different sizes. The mounting holes 22 may be configured (e.g., sized and/or shaped) to facilitate engagement of one or more items with the mounting platform 12, further details of which will be provided below.

The slots 24a-d are configured to receive and engage with a portion of a securing member 34 which may be used to releasably couple an item 36, such as a smart phone, camera, or a similar device, to the mounting platform 12. In the illustrated form, the securing member 34 is engaged with slots 24b and 24d. Additionally or alternatively, a securing member 34 may be present and engage with slots 24a and 24c. In one non-illustrated form, only one of slots 24a-d may be present and the securing member 34 may passed through the slot and around the mounting platform 12 in order to secure the item 36 to the mounting platform 12. In addition, the positioning of slots 24a-d may be varied relative to the illustrated form. For example, a pair of slots could be positioned opposite of one another and extend inline with or parallel to the first and second engaging members 14 and 16 such that the item 36 secured to the mounting platform 12 also extends inline with or parallel to the first and second engaging members 14 and 16. In contrast, in the illustrated form, the slots 24a-d and the item 36 secured to the mounting platform 12 extend transversely to the first and second engaging members 14 and 16. The securing member 34 may have any suitable form, and may be, for example, a strap formed of an elastomeric or fabric material.

In the illustrated form, the first and second engaging members 14 and 16 extend from the mounting platform 12 along a longitudinal axis L and, as such, may be considered as extending colinearly with one another. However, in other forms, the first engaging member 14 and the second engaging member 14 may extend transversely to one another. The first and second engaging members 14 and 16 may be formed integrally with the mounting platform 12 such that the mounting platform 12, the first engaging member 14, and the second engaging member 16 are formed as single piece or component. However, one or both of the first and second engaging members 14 and 16 may be a separate component which is coupled with the mounting platform 12 in a suitable fashion.

The first engaging member 14 extends from the mounting platform 12 and terminates at end 38. A plurality of receptacles 40 are positioned on the first engaging member 14 and open in a direction facing the same direction as the first surface 18 faces. The receptacles 40 generally include a U-shaped configuration in the illustrated form, although they may have a different configuration in other forms. The receptacles 40 are positioned adjacent to end 38, although other variations in the spacing and positioning of the receptacles 40 are possible. While three of the receptacles 40 are illustrated, different numbers of receptacles 40 may be present. For example, in one form, only a single receptacle 40 may be present. The receptacles 40 may be configured (i.e., sized and/or shaped) to interact with a portion of a fence. For example, in some embodiments, the receptacles 40 may be sized and shaped such that a portion of a fence, such as the wire of a chain link fence, may fit inside a receptacle 40 to removably fix the engaging member 14 in a particular position on the fence. The portion of the fence may, for example, be positioned in a receptacle 40 utilizing a press fit configuration where the size of the fence wire may be slightly larger than the receptacles which causes a slight deformation of the receptacle 40 and a resultant clamping action of the receptacle 40 on the portion of the fence. In these and other embodiments, the receptacles 40 may be sized based on a gauge of the wire in the fence. For example, the wires in a chain link fence may be #9, #11, or #11.5 gauge wire. Alternatively or additionally, in some embodiments, the receptacles 40 may be sized to interface with multiple gauges of wire. Alternatively or additionally, in some embodiments, one of the receptacles 40 may be configured to interface with one gauge of wire while another one of the receptacles 40 may be configured to interface with another gauge of wire. For example, in some embodiments, the first engaging member 14 may include one receptacle 40 sized to engage with #9 gauge wire, one receptacle 40 sized to engage with a #11 gauge wire, and one receptacle 40 sized to engage with a #20 gauge wire.

The second engaging member 16 extends from the mounting platform 12 and terminates at end 42. A plurality of receptacles 44 are positioned on the second engaging member 16 and open in a direction facing the same direction as the first surface 18 faces. The receptacles 44 generally include a C-shaped configuration in the illustrated form, although they may have a different configuration in other forms. The receptacles 44 are positioned adjacent to end 42, although other variations in the spacing and positioning of the receptacles 44 are possible. While seven of the receptacles 44 are illustrated, different numbers of the receptacles 44 may be present. For example, in one form, only a single receptacle 44 may be present. The receptacles 44 may be configured (i.e., sized and/or shaped) to interact with a portion of a fence. For example, in some embodiments, the receptacles 44 may be sized and shaped such that a portion of a fence, such as the wire of a chain link fence, may fit inside a receptacle 44. In some forms, in contrast to the receptacles 40, the receptacles 44 may receive a portion of the fence without resulting in a tight or press fit engagement with the portion of the fence. For example, the receptacles 44 may be wider than a corresponding receptacle 40 configured to receive the same gauge wire, may be shallower than a corresponding receptacle 40 configured to receive the same gauge wire, or both. However, in some forms the receptacles 44 could also provide this type of engagement. In these and other embodiments, the receptacles 44 may be sized based on a gauge of the wire in the fence. Alternatively or additionally, in some embodiments, the receptacles 44 may be sized to interface with multiple gauges of wire. Alternatively or additionally, in some embodiments, one of the receptacles 44 may be configured to interface with one gauge of wire while another one of the receptacles 44 may be configured to interface with another gauge of wire.

In some embodiments, the first engaging member 14 may include receptacles 40 on one surface of the first engaging member 14 corresponding with the first surface 18 of the mounting platform 12 but may not include the receptacles 40 on a second surface of the first engaging member 14 corresponding with the second surface 20 of the mounting platform 12. Alternatively or additionally, in some embodiments, the first engaging member 14 may include the receptacles 40 on both the first surface and the second surface of the first engaging member 14. Similarly, in some embodiments, the second engaging member 16 may include the receptacles 44 on a first surface of the second engaging member 16 but not on a second surface thereof. Additionally or alternatively, in some embodiments, the second engaging member 16 may include the receptacles 44 on both the first surface and the second surface, or may not include the receptacles 44 on either the first surface or the second surface.

While the first engaging member 14 includes receptacles 40 and the second engaging member 16 includes receptacles 44, in some embodiments, both the first engaging member 14 and the second engaging member 16 may include receptacles 40, both the first engaging member 14 and the second engaging member 16 may include receptacles 40, or both the first engaging member 14 and the second engaging member 16 may not include receptacles 40 or receptacles 44. In this last form for example, a surface of the first engaging member 14 and a surface of the second engaging member 16 may engage with a portion of the fence.

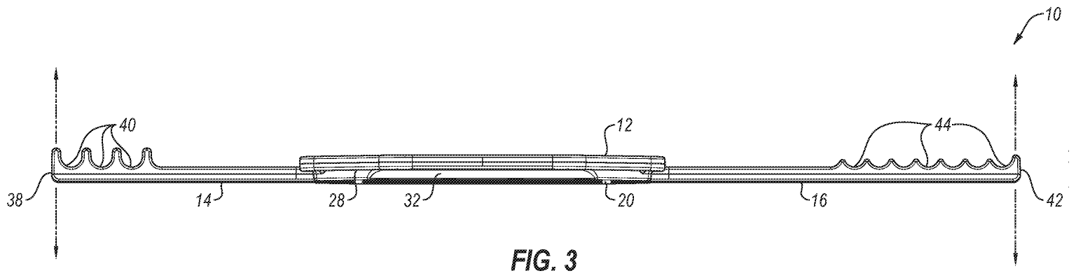

As will be described in greater detail below, the mounting device 10 may be releasably engaged with a fence. As the mounting device 10 is engaged with the fence, the first engaging member 14, the second engaging member 16 or both may be flexed or moved relative to the mounting platform 12 to position one or more of the receptacles 40 and/or one or more of the receptacles 44 on parts of the fence. For example, the mounting device 10 may be attached to a chain link fence where the receptacles 40 and the receptacles 44 may interface with the wire of the chain link face. Similarly, at least the portion of the first engaging member 14 including the receptacles 40 may be moved relative to the mounting platform 12 as shown by the direction arrows illustrated in FIG. 3, and at least the portion of the second engaging member 16 including the receptacles 44 may be moved relative to the mounting platform 12 as shown by the direction arrows illustrated in FIG. 3. The first engaging member 14 and the second engaging member 16 may also be moved relative to one another. In one form, the mounting device 10 may be formed of a material, or may be otherwise configured, such that the first engaging member 14 and the second engaging member 16 are returned to the illustrated form where the application of a force thereon is absent.

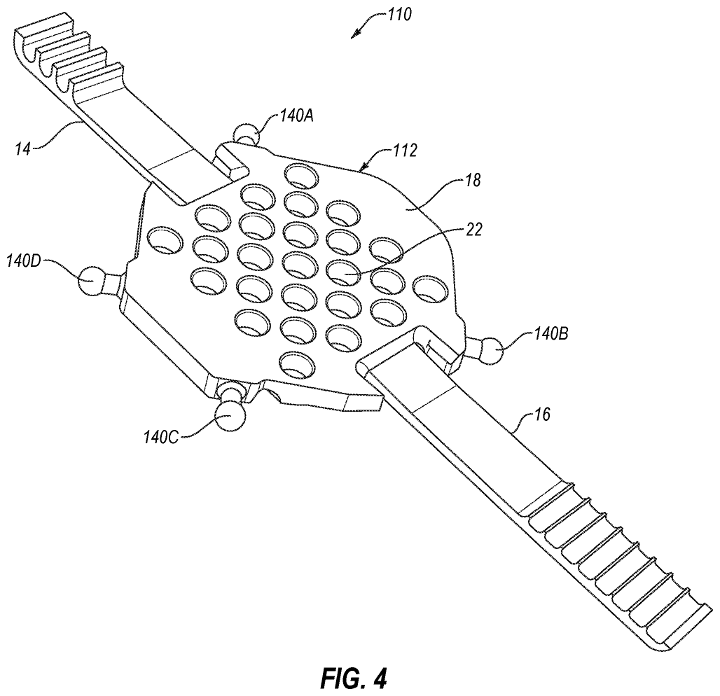

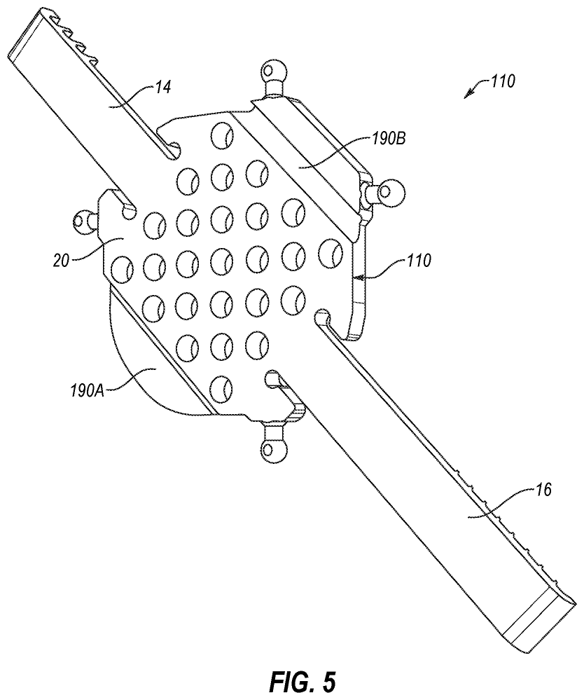

An alternative embodiment mounting device 110 is illustrated in FIGS. 4 and 5, where like reference numerals refer to like features previously described. The mounting device 110 is substantially similar to the mounting device 10, although the mounting platform 112 of the mounting device 110 includes a few differences relative to the mounting platform 10. For example, the mounting platform 112 includes multiple fixation posts 140A, 140B, 140C, and 140D (collectively the fixation posts 140). Alternatively or additionally, in some embodiments, the mounting platform 112 may include other anchor types such as snaps, eyelets, and/or hooks. While the mounting platform 112 is depicted with four fixation posts 140, in some embodiments, the mounting platform 112 may include a single fixation post 140, two fixation posts 140, three fixation posts 140, or any number of fixation posts 140. The fixation posts 140 may include a narrow body and a wider spherical-shaped head. In some embodiments, fixation posts 140 may be paired together in order to secure an item to the mounting platform 112. For example, fixation post 140A may be paired with fixation post 140C while fixation post 140B may be paired with fixation post 140D. In these and other embodiments, one fixation post 140 of each pair of fixation posts 140 may be positioned on opposite ends of the mounting platform 112. In some embodiments, the mounting platform 112 may include multiple pairs of fixation posts 140. In these and other embodiments, one pair of fixation posts 140 may be positioned on ends of the mounting platform 112 that are perpendicular or approximately perpendicular to the end of the mounting platform 112 on which another pair of fixation posts 140 are positioned. For example, the ends of the mounting platform 112 on which fixation posts 140A and 140C are positioned may be approximately perpendicular to the ends on which fixation posts 140B and 140D are positioned. In some embodiments, a device such as, for example, a camera or a smart cellular telephone, may be attached to the mounting platform 112 by placing a strap around the device and connecting the strap to a pair of the fixation posts 140.

As shown in FIG. 5 for example, the mounting platform 112 includes a first recessed mounting feature 190A and a second recessed mounting feature 190B (collectively the recessed mounting features 190). In some embodiments, the recessed mounting features 190 may be depressions in the second surface 20. In some embodiments, the recessed mounting features 190 may be aligned parallel with the first engaging member 14 and the second engaging member 16. Alternatively or additionally, in some embodiments, the recessed mounting features 190 may be positioned at a different angle relative to the first engaging member 14 and the second engaging member 16. In some embodiments, the first recessed mounting feature 190A and the second recessed mounting feature 190B may be separated by a distance. In some embodiments, the first recessed mounting feature 190A and the second recessed mounting feature 190B may be configured to interface with a fence. For example, in some embodiments, a chain link fence may have a particular mesh size. For example, mesh sizes for chain link fences may include 2 inches, 2¼ inches, 2⅜ inches, and 1¾ inches, amongst other possibilities. In these and other embodiments, the first recessed mounting feature 190A and the second recessed mounting feature 190B may be separated by a distance corresponding with the mesh size of the fence on which the mounting device 110 may be engaged. In these and other embodiments, when the mounting device 110 is attached to a fence, one wire of the fence may be positioned in the first recessed mounting feature 190A and a second wire of the fence may be positioned in the second recessed mounting feature 190B. In some embodiments, the first recessed mounting feature 190A may act as a fence anchor around three sides of a fence wire and the second recessed mounting feature 190B may act as a fence platform to allow compatibility with the fence's geometry differences.

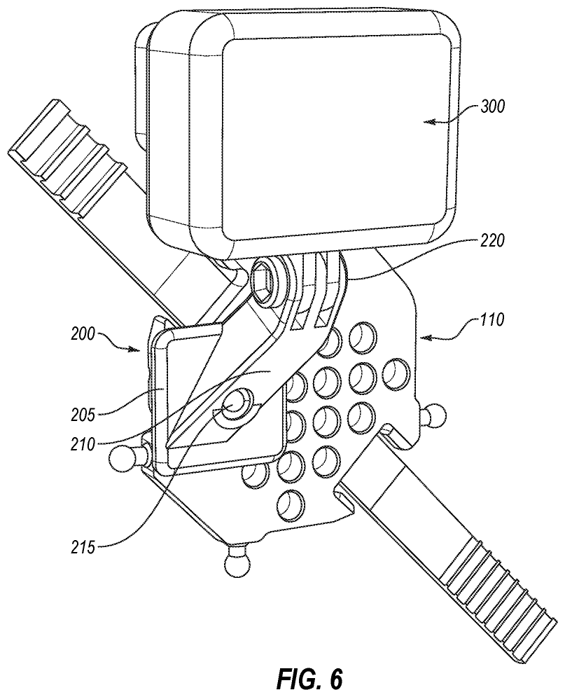

Referring now to FIG. 6, the mounting device 110 includes a mounting extension 200 coupled with the mounting platform 112, and a recording device such as camera 300 is coupled to the mounting extension 200. It should be appreciated that mounting extension 200 and camera 300 may be similarly mounted to the mounting device 10, and that the description following herein is also applicable to the mounting device 10. While the mounting extension 200 is present in FIG. 6, forms in which the camera 300 or some other item is directly mounted to the mounting platform 112 are also contemplated. The mounting extension 200 includes a base portion 205 from which a mounting stem 210 extends. A fastener 215 may extend through the base portion 205 and one of the mounting holes 22 where it can engage with a locking component (not shown). For example, the fastener 215 may be in the form of an externally threaded component which engages with an internally threaded component on an opposite side of the mounting platform 112. Alternatively, the fastener 215 could be configured to engage directly with the mounting holes 22. For example, the mounting holes 22 could be internally threaded in order to receive and engage with an externally threaded form of the fastener 215. The mounting extension 200 may be moved between different mounting holes 22 on the mounting platform 112 in order to provide the camera 300 with desired positioning for various different uses or settings.

The mounting stem 210 of the mounting extension 200 extends obliquely away from the base portion 205 such that a coupling portion 220 thereof is offset from the base portion 205. The coupling portion 220 is configured to receive a corresponding structure of the camera 300, or a case in which the camera 300 is positioned, in order to facilitate engagement of the camera 300 with the mounting extension 200. The amount by which the coupling portion 220 is offset from the base portion 205 may be sized such that a lens of the camera 300 is positioned in an opening in a fence. For example, when the mounting device 110 is engaged with a chain link fence, the mounting platform 112 may be positioned over an opening defined by wires forming the fence, and the mounting extension 200 may offset the camera 300 from the mounting platform so the lens of the camera is positioned in a different opening defined by wires forming the fence.

FIGS. 7 and 8 illustrate positioning and engagement of the mounting device 110 including the mounting extension 200 and the camera 300 relative to a fence 400. The fence 400 is illustrative of a chain link fence which includes a wire 405, or a plurality of wires 405, defining a plurality of openings 410. In the illustrated form, the mounting platform 112 of the mounting device 110 is generally positioned over opening 410a on a first side of the fence 400. The first engaging member 14 extends from the mounting platform 112 on the first side of the fence 400 through opening 410b of the fence 400 and engages with wire portion 405a on a second side of the fence 400. More particularly, the wire portion 405a is positioned in one of the receptacles 40 on the first engaging member 14. Similarly, the second engaging member 16 extends from the mounting platform 112 on the first side of the fence 400 through opening 410c of the fence 400 and engages with wire portion 405b on a second side of the fence 400. More particularly, the wire portion 405b is positioned in one of the receptacles 44 on the second engaging member 16. The mounting extension 200 offsets the camera 300 from the mounting platform 112 such that a lens 305 of the camera 300 is positioned in opening 410d of the fence 400.

In the illustrated form, the opening 410a is positioned between and immediately adjacent to the openings 410b and 410c. In other non-illustrated forms, one or both of the first engaging member 14 and the second engaging member 16 may sized such that they extend through an opening 410 that is not adjacent to the opening 410a. Since a plurality of receptacles 40 and 44 are provided on the first and second engaging members 14 and 16, respectively, positioning of the mounting device 110 relative to the fence 400 may be adjusted as indicated by the directional arrows shown in FIG. 7 by moving the wire portions 405a and 405b to different ones of the receptacles 40 and 44. Moreover, positioning of the mounting device 110 may also be adjusted relative to the fence 400 as indicated by the directional arrows shown in FIG. 8 by sliding the first and second engaging members 14 and 16 along the wire portions 405a and 405b. Positioning of the mounting device 110 may be adjusted, for example, to change positioning of the camera 300 relative to the opening 410d or the subject matter which it is capturing.

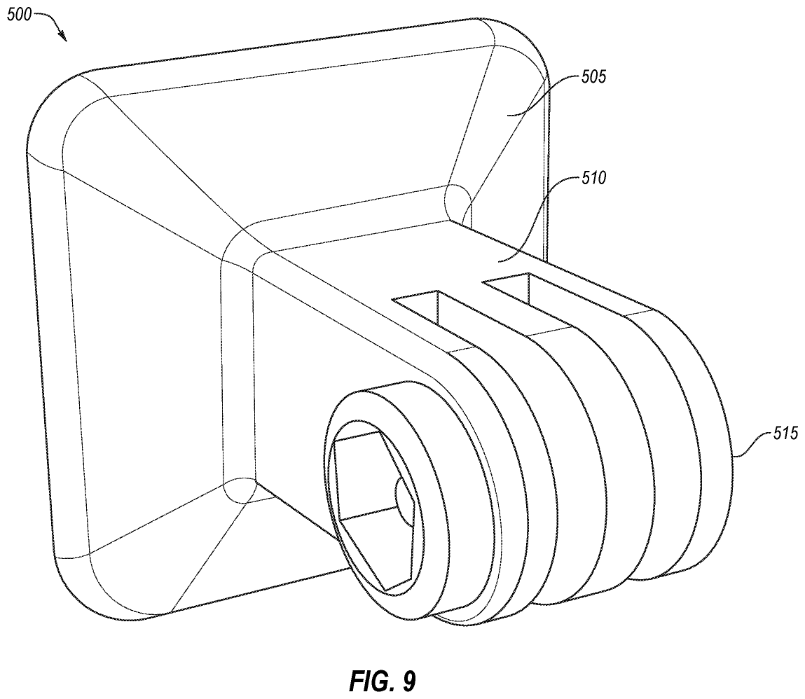

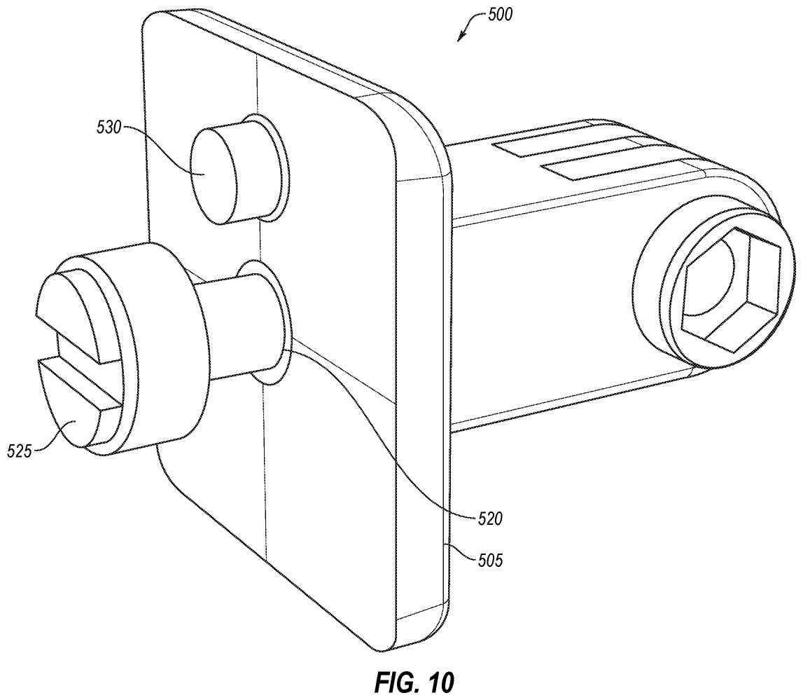

The mounting devices 10 and 110 disclosed herein could be used to position any suitable item relative to a fence or other structure to which the mounting devices 10 and 110 may be engaged. The items could be mounted directly to the mounting devices 10 and 110 or a component, such as mounting extension 200 may be present, and the item could be mounted to or coupled with the component. An alternative embodiment mounting extension 500 is illustrated in FIGS. 9 and 10. The mounting extension 500 includes a base portion 505 from which a mounting stem 510 extends and terminates with a coupling portion 515. The coupling portion 515 may, for example, be configured to receive a corresponding structure of the camera 300 or a case in which the camera 300 is positioned in order to facilitate engagement of the camera 300 with the mounting extension 500. In the illustrated form, the coupling stem 510 generally extends orthogonally from the base portion 505, although some variations are possible. The base portion 505 includes an internally threaded aperture 520 which may threadably receive an externally threaded fastener 525 which is sized and configured to be positioned through one of the mounting holes 22. The base portion 505 also includes a projection 530 which is sized and configured to be positioned in one of the mounting holes 22. With this arrangement of the base portion 505, it may be positioned against the mounting platform 12, 112 with the projection 530 positioned in one of the mounting holes 22 and the fastener 525 positioned in a different mounting hole 22. The fastener 525 may secure the base portion 505 to the mounting platform 12, 112, and the additional presence of the projection 530 in the mounting hole 22 may prevent movement or rotation of the mounting extension 500 relative to the mounting device 10 or 110. While the projection 530 in the illustrated form has a cylindrical configuration, it should be appreciated that alternative configurations of projection 530 are possible. Moreover, while described in connection with the mounting extension 500, the mounting extension 200 may also be configured to include a projection structured to prevent rotation of the mounting extension 200. The mounting extension 200 may also include a threaded aperture configured to receive a threaded fastener in lieu of the fastener 215, while the mounting extension 500 could include a fastener similar to fastener 215 in lieu of the threaded aperture 520.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A mounting device engageable with a fence, comprising:
a mounting platform;
a first engaging member extending from the mounting platform and including a number of receptacles configured to receive a portion of a fence wire; and
a second engaging member extending from the mounting platform and including a number of receptacles configured to receive a portion of a fence wire;
wherein a portion of the first engaging member including the number of receptacles is movable relative to the mounting platform and a portion of the second engaging member including the number of receptacles is movable relative to the mounting platform.

2. The device of claim 1, wherein each of the portion of the first engaging member including the number of receptacles and the portion of the second engaging member including the number of receptacles is movable transversely to a plane in which the mounting platform extends.

3. The device of claim 1, wherein the portion of the first engaging member including the number of receptacles and the portion of the second engaging member including the number of receptacles are movable relative to one another.

4. The device of claim 1, wherein a first surface of the mounting platform is configured to engage with a portion of a fence wire opposite of the portions of fence wire receivable by the receptacles of the first engaging member and the second engaging member.

5. The device of claim 1, wherein the first engaging member and the second engaging member are elastically deflectable relative to the mounting platform.

6. The device of claim 1, wherein the mounting platform includes a first surface, a second surface positioned opposite of the second surface, and a plurality of mounting holes extending between the first surface and the second surface.

7. The device of claim 6, further comprising a mounting extension engaged with one or more of the mounting holes.

8. The device of claim 1, wherein a first fixation post is positioned on a first side of the mounting platform and a second fixation post is positioned on an opposite, second side of the mounting platform.

9. The device of claim 1, wherein the first engaging member and the second engaging member are integrally formed with the mounting platform.

10. The device of claim 0, wherein the first engaging member and the second engaging member extend along a common longitudinal axis.

11. The device of claim 1, wherein the mounting platform includes a plurality of slots positioned between and extending transversely to the first engaging member and the second engaging member.

12. The device of claim 11, further comprising a securing member engageable with a pair of oppositely positioned slots.

13. The device of claim 1, wherein the number of receptacles on the first engaging member include a substantially U-shaped configuration and the number of receptacles on the second engaging member include a substantially C-shaped configuration.

14. A method for engaging a mounting device to a fence, comprising:
positioning a portion of a first engaging member of the mounting device on a first side of the fence and receiving a portion of a fence wire in a receptacle of the first engaging member;
positioning a portion of a second engaging member of the mounting device on the first side of the fence and receiving a portion of a fence wire in a receptacle of the second engaging member; and
maintaining a mounting platform from which the first engaging member and the second engaging member extend on a second side of the fence opposite the first side of the fence.

15. The method of claim 14, further comprising engaging a recording device to the mounting device.

16. The method of claim 14, wherein positioning the portion of the first engaging member of the mounting device on the first side of the fence includes deflecting a portion of the first engaging member away from the mounting platform.

17. The method of claim 14, wherein positioning the portion of the second engaging member of the mounting device on the first side of the fence includes deflecting a portion of the second engaging member away from the mounting platform.

18. The method of claim 14, wherein the fence has a plurality of openings and the first engaging member extends through a first opening of the fence, the mounting platform is positioned over a second opening of the fence, and the second engaging member extends through a third opening of the fence.

19. The method of claim 18, wherein the second opening is positioned between and adjacent to the first opening and the third opening.
